(19) United States
(12) Patent Application Publication
(10) Pub. No.: US 2015/0045517 A1
(43) Pub. Date: Feb. 12, 2015

(54) CURABLE RESIN COMPOSITION, CURED PRODUCT AND METHOD OF PRODUCING A CURED PRODUCT

(71) Applicants: Henkel AG & Co. KGaA, Duesseldorf (DE); National University Corporation Yokohama National University, Kanagawa (JP)

(72) Inventors: Akio Takahashi, Kanagawa (JP); Kohei Hirao, Kanagawa (JP); Toshiyuki Oyama, Kanagawa (JP); Rainer Schoenfeld, Duesseldorf (DE)

(21) Appl. No.: 14/523,322

(22) Filed: Oct. 24, 2014

Related U.S. Application Data
(63) Continuation of application No. PCT/JP2013/062148, filed on Apr. 18, 2013.
Application No. PCT/JP2013/062148 is a continuation of application No. PCT/JP2012/061693, filed on Apr. 25, 2012.

(51) Int. Cl. C08L 79/02

(52) U.S. Cl. CPC C08L 79/02; C08L 2205/03
USPC 525/411

(57) ABSTRACT

A curable resin composition contains (a) a matrix resin component containing a benzoxazine compound (a1), (b) a radically polymerizable component containing a radically polymerizable monomer having solubility parameter (SP) value that is different by 1.0 to 4.1 from the SP of the matrix resin component, and (c) a radical polymerization initiator. The composition has a low viscosity, and its cured product has an improved toughness and excellent mechanical properties.

### TECHNICAL FIELD

The present invention relates to a thermally curable resin composition containing one or more benzoxazine compounds and in detail, to a benzoxazine-based thermally curable resin composition having an improved toughness and a low viscosity.

### BACKGROUND ART

Benzoxazine-based resins are thermally cured with little generation of volatile components and in general, the resins have a high glass transition temperature and a high mechanical strength, and in addition, good electrical properties and a low flammability. For this reason, the resins are useful as a matrix material in a fiber-reinforced composite material, an adhesive, a sealant and the like in the applications of aerospace industries and electronic components.

Blends of benzoxazine-based resins with other resins are known, for example, a blend of an epoxy resin and benzoxazine, a ternary blend of an epoxy resin, benzoxazine and a phenol resin, and the like have been known (see the section of Background of the Invention of the patent document 1 (JP A 2007-524728: WO2005/000955) and the patent document 2 (JPA 2009-518465: WO2007/064801)).

As a general drawback of benzoxazine-based resins, it is known that their toughness is low. In order to improve the toughness, the patent document 1 discloses a composition containing a benzoxazine-based resin and an acrylonitrile-butadiene copolymer as a toughener, and the patent document 2 also discloses a composition comprising a benzoxazine-based resin and a specific adduct.

### CITATION LIST

### Patent Literature

Patent Document 1: JP A 2007-524728 (WO2005/000955)

Patent Document 2: JPA 2009-518465 (WO2007/064801)

### SUMMARY OF THE INVENTION

### Technical Problem

In recent years, for example, carbon fiber reinforced resins are on the way of utilization as a structural material of airplanes and automobiles for saving energy and achieving fuel efficiency. An improvement in reliability requires further improvement in strength and toughening of a matrix resin. In order to improve the reliability as a structural material, there is a need for benzoxazine-based thermally curable resin compositions having further improved mechanical properties, in particular improved toughness, wherein the toughening does not negatively effect the glass transition temperature of the cured product of these compositions.

On the other hand, a resin composition with a low viscosity is required in the Resin Transfer process such as the Resin Transfer Molding (RTM). This is because the lowered viscosity of a resin to be transferred would reduce the time of resin transfer, which allows for reducing the cycle time of molding. However, there has been a problem in that viscosity of an uncured composition is increased with a method for heightening toughness by addition of a polymer and the like as a toughener.

Therefore, it is an object of the present invention to provide a benzoxazine-based curable resin compositions which exhibit a low viscosity and are capable of giving cured products with improved mechanical properties, such as improved toughness.

### Solution to Problem

One aspect of the present invention relates a curable resin composition comprising:

(a) a matrix resin component containing (a1) a benzoxazine compound,

(b) a radically polymerizable component containing a radically polymerizable compound having solubility parameter (SP) value that is different by 1.0 to 4.1 from the SP value of the matrix resin component, and

(c) a radical polymerization initiator.

Another aspect of the present invention relates to a curable compositions comprising:

(a) a matrix resin component containing a benzoxazine compound (a1),

(b) a radically polymerizable component containing a radically polymerizable monomer that is polymerizable in the presence of the matrix resin component (a), and

(c) a radical polymerization initiator.

(d) Unless explicitly stated otherwise, the curable resin composition and the curable composition of the present invention both may be represented by the term “composition” in the following description.

### Advantageous Effect of Invention

The present invention can provide a benzoxazine-based curable, in particular thermally curable, resin composition with a low viscosity. This composition gives a cured product with improved mechanical properties, in particular improved toughness without significant detraction in a glass transition temperature. Therefore, the composition of the present invention is suitable as a structural material of airplanes and automobiles, and it is also useful as a sealant for electronic components.

### BRIEF DESCRIPTION OF DRAWINGS

FIG. 1 shows the relation of viscosity vs. temperature of the compositions of Examples 1 to 3 and Comparative example 1.

FIG. 2 shows the relation of viscosity vs. temperature of the compositions of Example 6 and Comparative examples 1 and 2.

FIG. 3 shows the relation of viscosity vs. temperature of the compositions of Example 20, Comparative examples 2 and 4 and TEPO.

### DESCRIPTION OF EMBODIMENTS

As mentioned above, the curable resin composition of the present invention contains (a) a matrix resin component containing a benzoxazine compound (a1), (b) a radically polymerizable component containing a radically polymerizable monomer having solubility parameter (SP) value that is different by 1.0 to 4.1 from the SP value of the matrix resin component, and (c) a radical polymerization initiator.

When the curable resin composition of the present invention is cured, the cured benzoxazine resin (a1) forms a matrix in which the cured products of (b) the radically polymerizable component are dispersed in the form of discrete domains with an appropriate size, which function as a modifier contributing to the improvement of toughness of the cured product.

In the present invention, the difference between the SP value of the matrix resin component and the SP value of the radically polymerizable monomer ranges from 1.0 to 4.1, preferably from 1.6 to 3.1, more preferably 1.8 to 3.1. If the SP value of the benzoxazine component is close to the SP value of the radically polymerizable monomer, benzoxazine and the radically polymerizable monomer are well miscible together in a mixture. When a radical polymerization is carried out in this state, the polymerization is inhibited by a chain transfer reaction and the degree of polymerization of the polymer from the radically polymerizable monomer does not increase, and thus no or too small domains are formed and an insufficient toughening performance is observed. On the other hand, if the SP value of the benzoxazine differs from the SP value of the radically polymerizable monomer too much, the size of the domains becomes large and the interface of the domains becomes readily separable. Therefore, the radically polymerizable monomer is selected so that it has the SP value described above relative to the matrix resin (i.e. the benzoxazine compound to be used and if present the co-curable resin component described later).

In the present invention, solubility parameter (SP) value is obtained from the equation:

δ=((ΔH^{v}−RT)/V)^{1/2}

wherein δ: solubility parameter, ΔH^{v}: evaporation enthalpy change, R: gas constant, T: absolute temperature, V: molar volume. ΔH^{v} can be estimated from a molecular structure. In the present invention, SP value was determined based on the data described in the literature by Toshinao Okitsu, Journal of the Adhesion Society of Japan, vol. 29, No. 5, 204-211(1993).

A further aspect of the present invention is a curable compositions comprising: (a) a matrix resin component containing a benzoxazine compound (a1), (b) a radically polymerizable component containing a radically polymerizable monomer that is polymerizable in the presence of the matrix resin component (a), and (c) a radical polymerization initiator. In one embodiment of the present invention the polymerizable monomer of the curable composition has a solubility parameter (SP) value that is different by 1.0 to 4.1, preferably by 1.6 to 3.1, more preferably 1.8 to 3.1 from the SP value of the matrix resin component.

Herein, the phrase “polymerizable in the presence of the matrix resin component” means that the polymerization of the radically polymerizable component is not hindered by the matrix resin component, in particular by the benzoxazine, i.e. the radically polymerizable component polymerizes up to such a molecular weight that the toughening of the cured product is observed. For example, polymerization degree more than about 5 is necessary. In terms of the weight averaged molecular weight, it is at least 500 or more, preferably 1000 or more, more preferably 5000 or more, further preferably 10,000 or more, most preferably 30,000 or more.

In addition, the term “in the presence of the benzoxazine component” means that the benzoxazine component is not cured substantially, preferably it is in liquid state, during the polymerization of the radically polymerizable component.

In addition, as will be mentioned later, a monomer with a low molecular weight may be selected as the radically polymerizable monomer. This allows the composition of the present invention to be of a low viscosity and thus, the composition is suitable for the resin transfer process such as the RTM in general. Each component of the compositions of the present invention will be explained below.

Matrix Resin Component (a)

The matrix resin component comprises a benzoxazine compound (a1) as an essential component and optionally a co-curable resin component (a2). The benzoxazine compound may be used alone or in combination of two or more compounds. The co-curable resin may also used alone or in combination of two or more compounds. In embodiments where the matrix resin component includes two or more than two resins or compounds, the SP value of the matrix resin component is the average (i.e. weighted average taking into account proportions by weight; SPₐᵥₑ) of the SP values of each resin or compound. For example, the average SP value of the matrix resin composition containing A % by weight of resin A having SP value of SPₐ and B % by weight of resin B having SP value of SP_{b} is given by the equation:

SPₐᵥₑ=(SPₐ×A+SP_{b}×B)/(A+B).

Benzoxazine Compound (a1)

The benzoxazine compound (a1) contained in the composition may be one or more benzoxazine compounds. In the present invention, a range of the preferred SP value for the benzoxazine component is determined relative to a range of the SP value for the radically polymerizable monomer. Although therefore, the SP value for the benzoxazine compound is not particularly limited, a benzoxazine compound having a SP value within a range, for example from 10 to 15 is used in a specific embodiment of the present invention.

The examples of benzoxazine compound (a1) includes compounds embraced by the following structure:

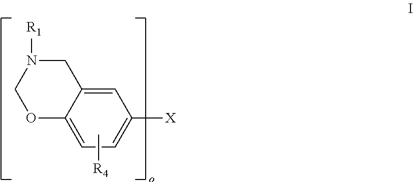

where o is 1-4, X is selected from a direct bond (when o is 2), alkyl (when o is 1), alkylene (when o is 2-4), carbonyl (when o is 2), thiol (when o is 1), thioether (when o is 2), sulfoxide (when o is 2), and sulfone (when o is 2), R₁ is selected from hydrogen, alkyl, alkenyl and aryl, and R₄ is selected from hydrogen, halogen, alkyl and alkenyl.

More specifically, within structure I the benzoxazine may be embraced by the following structure:

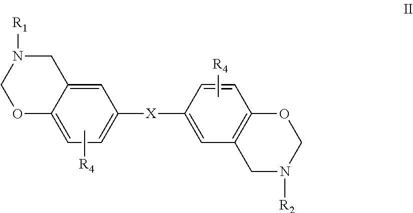

where X is selected from a direct bond, CH₂, C(CH₃)₂, C═O, S, S═O and O═S═O, R₁ and R₂ are the same or different and are selected from hydrogen, alkyl, such as methyl, ethyl, propyls and butyls, alkenyl, such as allyl, and aryl and R₄ are the same or different and are selected from hydrogen or alkenyl, such as allyl.

Representative benzoxazines within structure II include:

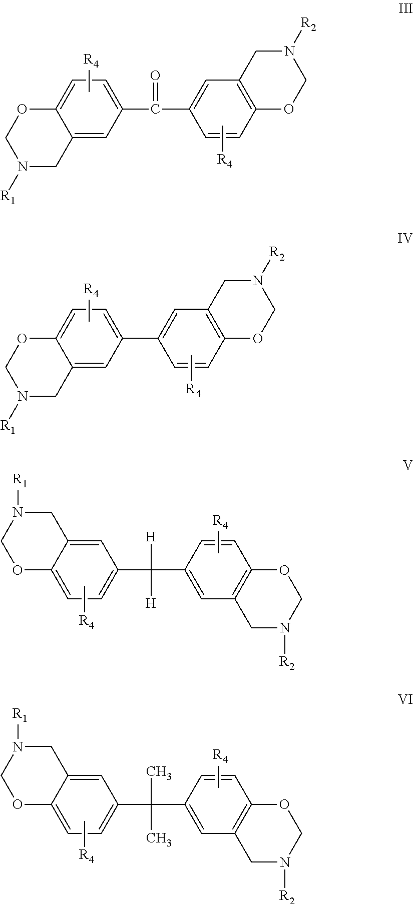

where R₁, R₂ and R₄ are as defined above.

Alternatively, the benzoxazine may be embraced by the following structure:

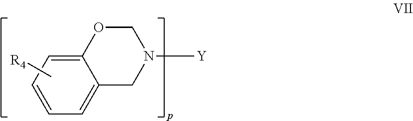

where p is 2, Y is selected from biphenyl (when p is 2), diphenyl methane (when p is 2), diphenyl isopropane (when p is 2), diphenyl sulfide (when p is 2), diphenyl sulfoxide (when p is 2), diphenyl sulfone (when p is 2), and diphenyl ketone (when p is 2), and R₄ is selected from hydrogen, halogen, alkyl and alkenyl.

Though not embraced by structures I or VII additional benzoxazines are within the following structures:

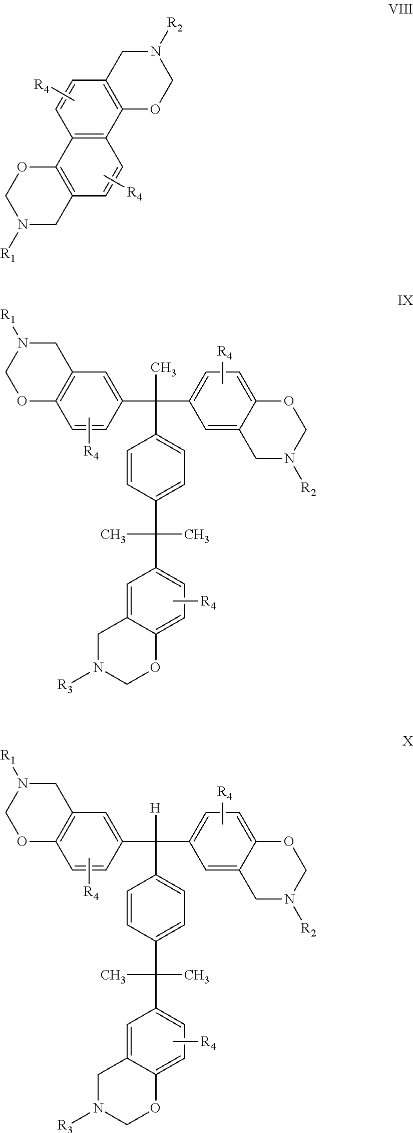

where R₁, R₂ and R₄ are as defined above, and R₃ is defined as R₁ R₂ or R₄.

Furthermore, the benzoxazine may be embraced by the following structure:

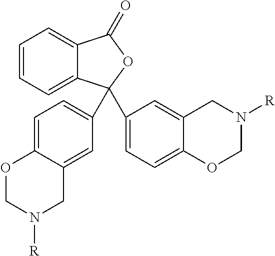

where R is allyl, aryl, alkyl such C₁-C₈ Alkyl and cycloalkyl such as C₃-C₈ Cycloalkyl.

Specific examples of these benzoxazines include following compounds.

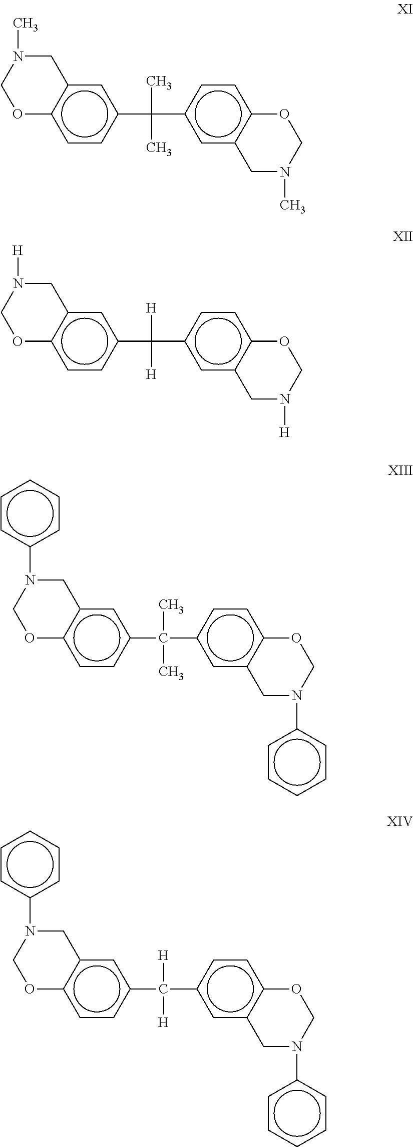

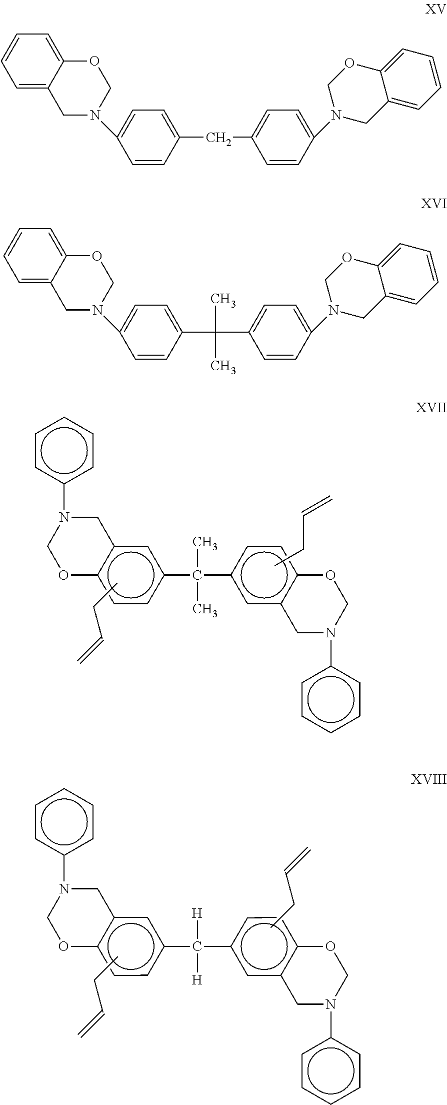

The benzoxazine compound may include the combination of multifunctional benzoxazines and monofunctional benzoxazines, or may be the combination of one or more multifunctional benzoxazines or one or more monofunctional benzoxazines.

Examples of monofunctional benzoxazines may be embraced by the following structure:

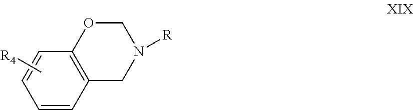

where R is alkyl, such as methyl, ethyl, propyls and butyls, or aryl with or without substitution on one, some or all of the available substitutable sites, and R₄ is selected from hydrogen, halogen, alkyl and alkenyl.

For instance, monofunctional benzoxazines may be embraced by the structure

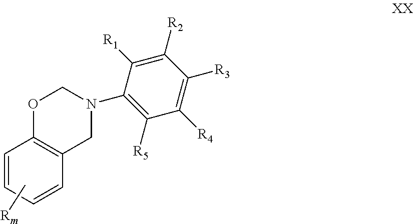

where in this case R is selected from alkyl, alkenyl, each of which being optionally substituted or interupted by one or more O, N, S, C═O, COO, and NHC═O, and aryl; m is 0-4; and R₁-R₅ are independently selected from hydrogen, alkyl, alkenyl, each of which being optionally substituted or interupted by one or more O, N, S, C═O, COOH, and NHC═O, and aryl.

Specific examples of such a monofunctional benzoxazine are:

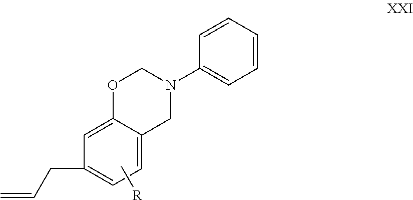

where R is as defined above; or

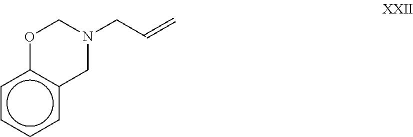

Co-Curable Resin Component (a2)

Although the co-curable resin component (a2) is not an essential component of the composition of the present invention, the component may be added as necessary in order to improve physical properties of the composition such as, viscosity, and/or mechanical properties of the cured product. The co-curable resin component (a2) that may be used is that capable of co-curing by reacting with the benzoxazine compound, or that which is not react with the benzoxazine compound but curable independently in a state of dissolution. In addition, preference is given to a resin not inhibiting the radical polymerization.

The co-curable resin component (a2) includes thermosetting resins such as epoxy resins, cyanate resins, phenolic resins, urea resins, melamine resins, unsaturated polyester resins and polyurethanes. Among these, preference is given to epoxy resins, cyanate resins, phenolic resins, melamine resins and urea resins, and more preference is given to epoxy resins. These co-curable resins may be used alone or in combination of two or more resins.

As epoxy resins, epoxy resins having aromatic ring(s), alicyclic epoxy resins or a variety of other epoxy resins may be used. A single epoxy resin may be used or two or more epoxy resins may be used. In addition, it is preferred that the epoxy resin has at least one aromatic because it provides a cured product having excellent mechanical strength and heat resistance.

The epoxy resins having aromatic ring(s) includes bisphenol-type epoxy resins such as bisphenol A-type epoxy resin, bisphenol F-type epoxy resin and bisphenol S-type epoxy resin; novolak-type epoxy resins such as phenol novolak-type epoxy resin and cresol novolak-type epoxy resin; biphenyl-type epoxy resin of the product name YX4000 made by Japan Epoxy Resins Co., Ltd.; epoxy resins having aromatic group(s) with multiple rings in its basic backbone such as naphthalene, anthracene and terphenyl; and furthermore tetraglycidyl diaminodiphenylmethane (TGDDM), triglycidyl para-aminophenol, triglycidyl meta-aminophenol and the like. The epoxy resin having aromatic ring(s) usually has one or more, preferably two or more epoxy groups in its molecule and an epoxy equivalent may be selected arbitrarily.

The alicyclic epoxy resins include those having epoxy group with ring distortion such as a cyclohexene oxide structure and a cyclopentene oxide structure in its molecule. Specifically, preference is given to those having two or more such epoxy groups in its molecule. Typical examples of alicyclic epoxy resins include compounds represented by the following formulae (1) to (5). The alicyclic epoxy resins may be used alone or preferably in combination with other epoxy compound, particularly with epoxy resin having aromatic ring(s)

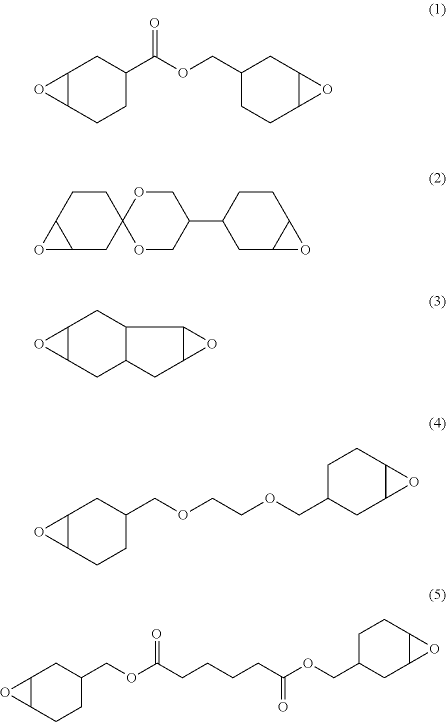 [SMILES: O=C(OCC1CCC2OC2C1)C1CCC2OC2C1 ; C1CC2OC2CC1C1COC2(CCC3OC3C2)OC1 ; C1C2CC3OC3C2CC2OC12 ; C(COCC1CCC2OC2C1)OCC1CCC2OC2C1 ; O=C(CCCCC(=O)OCC1CCC2OC2C1)OCC1CCC2OC2C1]

In the present invention, at least an epoxy resin selected from the group consisting of hydrogenated bisphenol type epoxy resins and dicyclopentadiene type epoxy resins may be used. These epoxy resins may be used alone or in combination with another epoxy resin, specifically, preferably with the aromatic-ring containing epoxy resin.

Hydrogenated bisphenol epoxy resins are compounds obtainable by hydrogenating benzene-rings in bisphenol epoxy resins such as bisphenol-A epoxy resins, bisphenol-F epoxy resins, bisphenol-S epoxy resins and the like. Hydrogenated bisphenol-A epoxy resin is represented by the following formula:

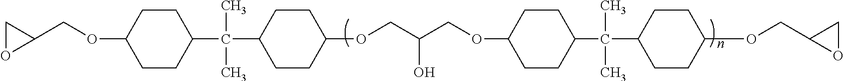

The above compound is generally obtained as a mixture with different number n and the average of n is 0 to about 5, for example 0 to about 2, particularly in the range of 0 to 1.

In addition, the dicyclopentadiene-type epoxy resin is represented by the following formula:

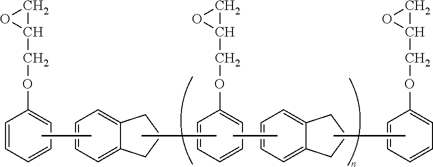

which is usually generally obtained as a mixture with different number n and the average of n is 0 to about 5, for example 0 to about 2, particularly in the range of 0 to 1.

The cyanate resin includes novolac-type cyanate resin, bisphenol A-type cyanate resin, bisphenol E-type cyanate resin, tetramethyl bisphenol F-type cyanate resin and the like.

In addition, the phenolic resin includes novolac-type phenolic resin and resol-type phenolic resin. As the melamine resin, methylol melamine is used usually.

When the co-curable resin component (a2) is present, the SP value of the matrix resin component is obtained by the average (a weighted average taking into account proportions by weight) of the benzoxazine compound (a1) and the co-curable resin component (a2), and it is preferred that the difference from the SP value of the radically polymerizable monomer (preferably the SP value of the radically polymerizable component (b)) is within a range from 1.0 to 4.1, more preferably from 1.6 to 3.1, further preferably from 1.8 to 3.1.

Radically Polymerizable Component (b)

The radically polymerizable component (b) comprises at least one radically polymerizable monomer having a solubility parameter (SP) value within a range different by 1.0 to 4.1 (preferably 1.6 to 3.1, more preferably 1.8 to 3.1) from the solubility parameter (SP) value of the matrix resin component. When the radically polymerizable component (b) contains two or more radically polymerizable monomers, it is preferred that the average SP value of the “radically polymerizable component (b)” is within the above-described range. More preferably, all radically polymerizable monomers contained in the radically polymerizable component (b) have the above-described SP value. Herein, the average SP value of the radically polymerizable component is the average (a weighted average taking into account proportions by weight) of the SP values of each monomer. For example, the average SP value (SPₐᵥₑ) of the radically polymerizable component containing A % by weight of monomer A having SP value of SPₐ and B % by weight of monomer B having SP value of SP_{b} is given by the equation:

SPₐᵥₑ=(SPₐ×A+SP_{b}×B)/(A+B).

The radically polymerizable monomer is usually selected so that its SP value is smaller than the SP value of the matrix resin component.

In a specific embodiment of the present invention, the radically polymerizable component (b) contains, preferably consists of, the radically polymerizable monomer(s) having the SP value within a range from 7 to 10.5, preferably a range from 8 to 9.5.

The radically polymerizable monomer has one or more, preferably only one functional group (here, a functional group also includes an atomic group), which performs radical chain polymerization under a condition for radical polymerization. Although preference is usually given to a monomer having in its molecule only one radically polymerizable functional group, for example carbon-carbon double bond, preference is also given to a monomer wherein, even if there are two radically polymerizable functional groups, only one group is capable of involving in polymerization reaction, or two or more functional groups function as one atomic group performing radical chain polymerization like for example, 1,4-addition polymerization of a conjugated diene.

In the first aspect of the invention, the radically polymerizable monomer usable for the present invention has been discussed in terms of its SP value. However, in the second aspect of the present invention, the radically polymerizable monomer usable for the present invention is selected from the point of view whether it is polymerized in the presence of the matrix resin component containing a benzoxazine compound to give a polymer. The polymer that has been polymerized in the matrix resin component should have degree of polymerization of more than about 5. In terms of molecular weight, the polymer should have a weight average molecular weight of about 500 g/mol or larger, preferably 1000 g/mol or larger, more preferably 5000 g/mol or larger, further preferably 10,000 g/mol or larger and most preferably 30,000 g/mol or larger. Thus, the radically polymerizable monomer is selected so that it gives polymer after radical polymerization in the matrix resin. Herein, the weight average molecular weight is determined by, for example, GPC (gel permeation chromatography) using a calibration curve obtained using standard polystyrenes.

Specific examples of the radically polymerizable monomer usable for the present invention are as follows. However, usable polymers are determined in relation to, in particular in terms of SP value relative to, the benzoxazine compound, or the benzoxazine compound and the co-curable resin component if the co-curable resin component is present. Thus, monomers not listed below may be usable or monomers listed below may not be usable depending the case. The monomers mentioned below relate to both the first aspect and the second aspect of the present invention.

Namely, a styrene-based monomer, for example styrene; an α-alkyl styrene such as α-methyl styrene (the number of carbon atoms in the alkyl is preferably from 1 to 4); a halogen-substituted, alkyl-substituted, alkoxy-substituted or oxaalkyl-substituted styrene such as chlorostyrene and vinyl toluene; (the number of carbon atoms in the alkyl, alkoxy and oxaalkyl is preferably from 1 to 12, and more preferably from 1 to 4.); a styrene-polyoxyalkylene adduct such as vinylbenzyl-ω-methylpolyoxyethylene oxide; a hydroxyl group-substituted styrene such as hydroxystyrene; as others, styrene derivatives substituted with group(s) not involving in radical reaction and the like;

a (meth)acrylic monomer, in particular aliphatic (meth)acrylate, for example ethyl(meth)acrylate, n-propyl(meth)acrylate, isopropyl(meth)acrylate, n-butyl(meth)acrylate, isobutyl(meth)acrylate, tert-butyl(meth)acrylate, n-pentyl(meth)acrylate, n-hexyl(meth)acrylate, cyclohexyl(meth)acrylate, n-heptyl(meth)acrylate, n-octyl(meth)acrylate, 2-ethylhexyl(meth)acrylate, nonyl(meth)acrylate, decyl(meth)acrylate, dodecyl(meth)acrylate, 2-methoxyethyl(meth)acrylate, 3-methoxybutyl(meth)acrylate, 2-hydroxyethyl(meth)acrylate, 2-hydroxypropyl(meth)acrylate, stearyl(meth)acrylate, glycidyl(meth)acrylate, 2-aminoethyl(meth)acrylate, γ-(methacryloyloxypropyl)trimethoxysilane, (meth)acrylic acid-ethylene oxide adduct, trifluoromethylmethyl(meth)acrylate, 2-trifluoromethylethyl(meth)acrylate, 2-perfluoroethylethyl(meth)acrylate, 2-perfluoroethyl-2-perfluorobutylethyl(meth)acrylate, 2-perfluoroethyl(meth)acrylate, perfluoromethyl(meth)acrylate, diperfluoromethylmethyl(meth)acrylate, 2-perfluoromethyl-2-perfluoroethylmethyl(meth)acrylate, 2-perfluorohexylethyl(meth)acrylate, 2-perfluorodecylethyl(meth)acrylate, 2-perfluorohexadecylethyl(meth)acrylate, and the like;

a fluorine-containing vinyl monomer, for example perfluoroethylene, perfluoropropylene, vinylidene fluoride and the like;

a silicon-containing vinyl monomer, for example vinyltrimethoxysilane, vinyltriethoxysilane and the like;

maleic anhydride, maleic acid, and a monoalkyl ester and dialkyl ester of maleic acid;

fumaric acid, and a monoalkyl ester and dialkyl ester of fumaric acid;

a vinyl ester, for example vinyl acetate, vinyl propionate, vinyl pivalate, vinyl benzoate, vinyl cinnamate and the like;

an alkene, for example ethylene, propylene and the like;

a conjugated diene, for example butadiene, isoprene and the like; and

vinyl chloride, vinylidene chloride, allyl chloride, allyl alcohol and the like.

As mentioned above, these monomers may be used solely or may be used with plurality thereof.

In the descriptions above and below, the terms “(meth)acrylic”, “(meth)acrylate” and the like mean “methacrylic or acrylic”, “methacrylate or acrylate” and the like as customary used.

Among these, particular preference is given to a monomer giving a polymer excellent in heat resistance, and for example, preference is given to a styrene monomer and a (meth)acrylic monomer, and a mixture thereof, and particular preference is given to a monomer having aromatic ring(s) in its molecule and a mixture containing it. As a specifically preferred compound, preference is given to styrene, vinyl toluene, α-methylstyrene, and a C₂₋₁₆-, preferably C₂₋₁₂-alkyl(meth)acrylate.

In a preferred embodiment, a mixture of a styrene monomer and a C₂₋₁₆-, preferably C₂₋₁₂-alkyl(meth)acrylate is used. A mixing proportion in the mixture of a styrene monomer and a C₂₋₁₆-alkyl(meth)acrylate is, for example, in a range from 1:0.1 to 1:10, preferably in a range from 1:0.1 to 1:2 in a molar ratio.

In an embodiment of the present invention, it is also preferred that the radically polymerizable component (b) contains a monomer having in addition to radically polymerizable functional group(s), the second functional group which has a co-curing reactivity with the benzoxazine component (a), or has a curing reactivity in the presence of the benzoxazine component (a).

In the present invention, it is not necessary that the radically polymerizable component (b) contains a monomer having the radically polymerizable group(s) and the second functional group(s) not involving in radical polymerization (hereafter, being referred to as a “monomer having the second functional group(s)” for simplicity). Even when the radically polymerizable component (b) does not contain the monomer having the second functional group(s), a cured product can be obtained which has excellent properties in comparison with conventional products.

Although the monomer having the second functional group may be arbitrarily selected also considering existence or non-existence of the co-curable resin component (a2) and selection of its type, the monomer having the second functional group includes, for example a monomer having epoxy group(s). Specific examples include glycidyl(meth)acrylate, glycidyloxyphenylmaleimide and the like. A typical structure is shown as follows.

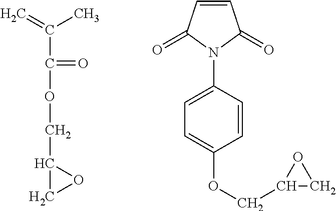

Radical Polymerization Initiator (c)

The radical polymerization initiator (c) is a component to polymerize the radically polymerizable component (b). Although as the radical polymerization initiator, may be used a variety of radical initiators such as a thermal radical initiator, a photoinitiator and a redox-type initiator, it is simple and preferred to use a thermal radical initiator. Specific preference is given to an organic peroxide such as benzoyl peroxide and dicumyl peroxide, and an azo compound such as 2,2′-azobisisobutyronitrile. An amount of the radical polymerization initiator to be added may be arbitrarily set, and use is made within a range, for example from 0.01 to 10 parts by weight relative to 100 parts by weight of the radically polymerizable component (b).

Toughener Component (d)

As necessary, the present invention may contain a toughener component (d) to further improve toughness. Even if the composition of the present invention contains toughener component, it has a viscosity lower than a conventional composition containing a toughener component.

The examples of the toughener component include elastomers such as acrylonitrile-butadiene copolymer and prepolymers. The acrylonitrile-butadiene copolymer is disclosed in WO2005/000955. As the prepolymer useful as a toughener component, WO2007/064801 discloses specific adducts, WO2009/075743 and WO2010/031826 discloses isocyanat-based toughners, and WO2011/012648 discloses oligomeric or polymeric urethane group-free polyether compounds. The disclosures of these documents are incorporated in this application by reference.

Specifically, WO2007/064801 discloses a combination of adducts is useful as toughener component, wherein one of adducts is prepared from hydroxy-containing compounds, isocyanate-containing compounds and a first phenolic compound and the second of adducts is prepared from the first adduct, an epoxy-containing compound and a second phenolic compound.

An example of forming the first and the second adducts are shown in the following scheme.

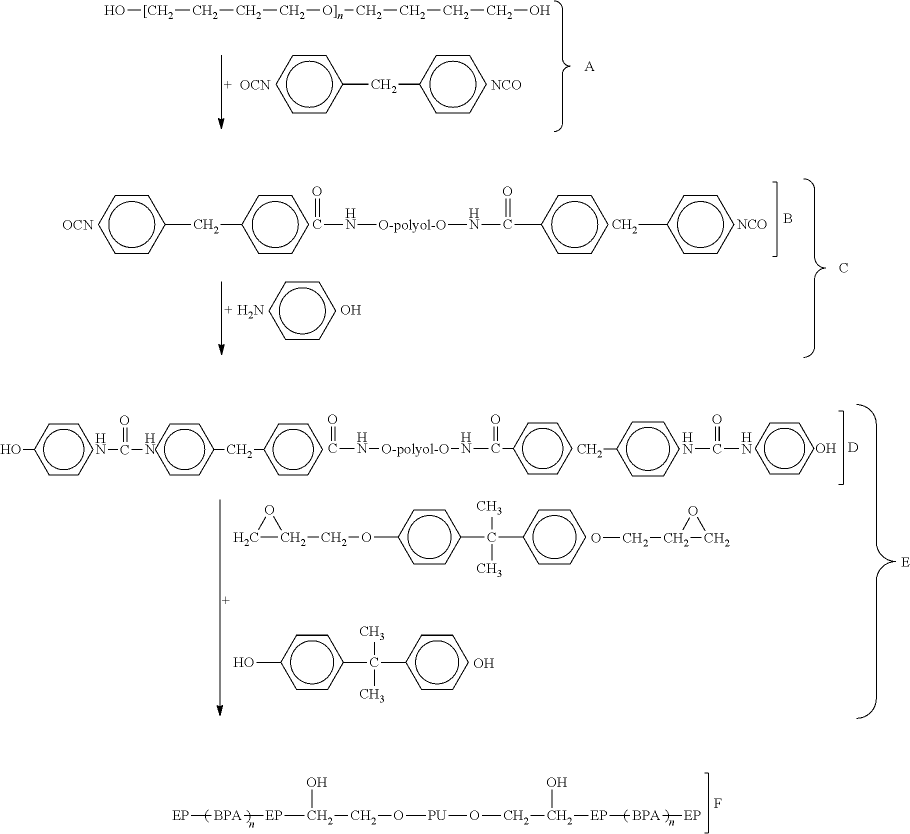

The first adduct is prepared from hydroxy-containing compounds, isocyanate-containing compounds and phenolic compounds. Portion A in the above scheme shows the reaction of a hydroxy-containing compound with an isocyanate-containing compound to yield a polyurethane with isocyanate terminal groups, shown as portion B. The polyurethane with isocyanate terminal groups is then reacted with a phenolic compound, here the hydroxyl amine p-amino phenol, to yield the first adduct, a hydroxy terminated polyurethane prepolymer, shown as portion D.

The second adduct is prepared from the first adduct, an epoxy-containing compound and a second phenolic compound. Portion E in the above scheme shows the reaction of the first adduct, an epoxy-containing compound and a second phenolic compound to yield epoxy terminated epoxy-polyurethane prepolymer, shown as portion F.

While WO2007/064801 teaches to use the two adducts in combination, these prepolymer may be used alone in the present invention.

WO2009/075743 discloses prepolymer having the general structure:

P—(X—CO—NH-D-NH—CO—Y-E)_{z}

wherein

P is a z-valent residue of an oligomer or polymer,

X and Y independently are selected from the group consisting of NR, O and S, wherein R′ is hydrogen or a residue selected from the group consisting of aliphatic, heteroaliphatic, araliphatic, heteroaraliphatic, aromatic and heteroaromatic residues,

D is a divalent residue of a diisocyanate comprising two isocyanate groups having different reactivity, from which the two isocyanate groups with different reactivity have been removed to form two binding sites (valences),

E is a end-capping residue, selected from the group consisting of aliphatic, heteroaliphatic, araliphatic, heteroaraliphatic, aromatic and heteroaromatic residues, and

z is an integer of 1 to 12.

In a preferred prepolymer, P is a polyether, X and Y are O, D is a residue obtained by removing the two isocyanate groups of 2,4-toluene diisocyanate or 2,4′-methylenediphenyl diisocyanate, E is an aromatic residue comprising a phenolic hydroxyl group, and z=2 or 3. Specific examples of the prepolymer that may be used in the present invention are those disclosed in examples of WO2009/075743.

WO2010/031826 discloses prepolymer having the general structure:

P—(X—CO—NH-D-NH—CO—Y-E)_{z}

wherein

P is a z-valent residue of an oligomer or polymer,

X and Y independently are selected from the group consisting of NR, O and S, wherein R′ is hydrogen or a residue selected from the group consisting of aliphatic, heteroaliphatic, araliphatic, heteroaraliphatic, aromatic and heteroaromatic residues,

D is a divalent residue obtained by removing the two isocyanate groups of a diisocyanate,

E is a end-capping residue, selected from the group consisting of aliphatic, heteroaliphatic, araliphatic, heteroaraliphatic, aromatic and heteroaromatic residues, and

z is an integer of 1 to 12,

wherein the prepolymer has a number average molecular weight in the range of 1000 to 54000 g/mol.

In a preferred prepolymer, P is a polyether, X and Y are O, D is a residue obtained by removing the two isocyanate groups of 2,4-toluene diisocyanate, 2,4′-methylenediphenyl diisocyanate, 4,4′-methylenediphenyl diisocyanate, hexamethylene diisocyanate, m-tetramethylxylene diisocyanate or isophorone diisocyanate, E is an aromatic residue comprising a phenolic hydroxyl group, and z=2 or 3. Specific examples of the prepolymer that may be used in the present invention are those disclosed in examples of WO2010/031826.

WO2011/012648 discloses oligomeric or polymeric urethane group-free polyether compound, comprising one or more structural elements of the general formula (I),

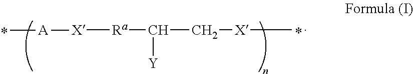

in which n is a number from 5 to 10,000, each residue R^{a} in each repeating unit independently denotes a divalent group of compounds comprising 1 to 100 C atoms, each residue X′ in each repeating unit is independently selected from —O—, —S—, —NH— or a carboxyl group of the general form —(C═O)O—, in which the C atom of the carboxyl group is always connected to the residue A, each residue Y in each repeating unit is independently selected from —OH, —SH and —NH₂ and each residue A in each repeating unit is independently selected from K or L, K denoting a divalent residue of aromatic dihydroxyl compounds following removal of both hydroxyl groups and L denoting a divalent residue of polyethers following removal of two terminal hydroxyl groups, with the proviso that, relative to the total number of all residues A in the oligomeric or polymeric urethane group-free polyether compound, 20 to 80% of all residues A denote K and 20 to 80% of all residues A denote L.

Very preferred prepolymers are those disclosed in examples of WO2011/012648, for example, those obtained by reacting bisphenol A, polypropylene glycol diglycidyl ether, and bisphenol A epoxy resin.

The above-mentioned toughner components are only examples. Other known toughner components may also be used in the present invention as long as they do not impair the purpose of the present invention.

Formulation Proportion of each Component

In the present invention, the formulation proportion of each component is as follows.

The matrix resin component (a) is used in a range from 10% by weight to 99.7% by weight, preferably from 40 to 99% by weight based on the composition as a whole.

The benzoxazine component (a1) is used in a range from 10% by weight to 99.7% by weight, preferably from 40 to 99% by weight based on the composition as a whole.

The co-curable resin component (a2) is used in a range from 0 to 80% by weight, preferably from 0 to 50% by weight based on the composition as a whole. When the co-curable resin component (a2) is present, it is used in a range not less than 0.1%, preferably not less than 1%, more preferably not less than 5%. When the co-curable resin component (a2) is an epoxy resin, an epoxy group equivalent ratio relative to benzoxazine group may be from about 0.05 to about 0.7, preferably about 0.1 to about 0.5.

The radically polymerizable component (b) is used in a range of preferably from 0.3 to 35% by weight, more preferably from 1 to 25% by weight, most preferably from 5 to 20% by weight based on the composition as a whole.

The radical polymerization initiator (c) is used, for example, in a range from 0.01 to 10 parts by weight relative to 100 parts by weight of the radically polymerizable component (b).

The toughener component (d) is used in a range from 0 to 30% by weight, preferably from 0 to 20% by weight based on the composition as a whole.

As necessary, the curable resin composition of the present invention may contain a curing accelerator for a benzoxazine compound and/or a curing agent or a curing accelerator for a co-curable resin component.

A method of producing the curable resin composition of the present invention is not particularly limited, and the above-described components (a1), (b) and (c) may be mixed, as necessary with the component (a2) and/or the component (d) and further an additive, which is/are added as necessary. A method of mixing is not particularly limited, and for example, the mixing may be carried out by heating within a temperature range not higher than a curing initiation temperature to improve liquidity.

The curable resin composition of the present invention is cured by heating in general in a range from 80 to 250° C., for example in a range from 100 to 220° C., for example for about 30 minutes to about 48 hours. Although in the present invention, polymerization of the radically polymerizable component and curing of the matrix resin component (a) (particularly benzoxazine compound (a1)) may be carried out separately or be carried out simultaneously, it is usually preferred that the polymerization of the radically polymerizable component progresses while the matrix resin component (a) is in a liquid state. That is to say, it is preferred that the matrix resin component (a) is cured once the radical polymerization of the radically polymerizable component has progressed sufficiently.

Without particular limitation, first the polymerization of the radically polymerizable component is initiated by exposing the composition under a condition where the radical polymerization initiator (c) generates a radical predominantly. In this condition, the curing of the matrix resin component (a) is sufficiently slow in comparison with the radical polymerization. Then, it is preferred to expose the composition under a condition where the curing of the matrix resin component (a) takes place faster. That is to say, a method of producing a cured product in an embodiment of the present invention comprising the steps of exposing the composition under a first condition where the polymerization of the radically polymerizable component (b) takes place predominantly, and exposing the composition under a second condition where the curing of the matrix resin component (a) takes place faster than under the first condition.

When the radical polymerization initiator (c) is a thermal radical initiator, it is preferred to employ a heating profile so that a temperature rises in a stepwise or continuous manner from a lower temperature to a higher temperature. Although it is preferred to arbitrarily select a temperature range depending on each component to be used, it is preferred to elevate a temperature in a stepwise or continuous manner up to, for example around 100° C. to around 220° C.

An example of the heating profile is exemplified. As the first step, the polymerization of the radically polymerizable component (b) is initiated and the polymerization is progressed by holding a temperature within a range from about 100° C. to 140° C., preferably about 110° C. to 130° C., for about 10 minutes to 5 hours, preferably 30 minutes to 3 hours. Although during this period, the curing of the matrix resin component (a) (particularly benzoxazine compound (a1)) is thought to be also initiated, the curing of the matrix resin component (a) does not take place in comparison with the progress of the polymerization of the radically polymerizable component (b). This first step corresponds to the above-mentioned first condition.

In the second step, a temperature higher than the first step is then kept within a temperature range, for example about 130° C. to 170° C., preferably about 140° C. to 160° C. for 1 hour to 24 hours, preferably about 4 hours to 15 hours. During this period, it is thought that the polymerization of the radically polymerizable component (b) is completed almost entirely in the second step, particularly in an earlier stage thereof. In the second step, the curing of the matrix resin component (a) (particularly benzoxazine compound (a1)) also progresses mostly. This second step and thereafter corresponds to the above-mentioned second condition.

In the third step, a temperature higher than the second step is furthermore kept within a temperature range, for example about 160° C. to 220° C., preferably about 170° C. to 210° C. for about 30 minutes to 15 hours, preferably about 1 hour to 8 hours to complete curing. When the composition does not contain the co-curable resin component (a2), heating is carried out usually within a range from about 160° C. to 200° C., preferably 170° C. to 190° C. When the composition contains the co-curable resin component (a2), the temperature differs depending on the selected materials and it is preferred that the temperature is elevated up to a range from 180° C. to 220° C. in the third step in case on the curing at high temperature is necessary. This heating may be carried out in a stepwise manner and the heating may be carried out, for example at a temperature not lower than about 190° C. for 30 minutes to 10 hours after heating within a range from about 170° C. to 190° C. for 30 minutes to 3 hours.

The above profile for heating and curing is an example, and the profile may be arbitrarily altered in accordance with the materials to be selected for each component.

In addition depending on applications, the step of curing may be interrupted and stopped in a state where the curable composition has been cured partially. The partially cured product obtained by this interruption is referred to as the B-stage resin, which is suitable for, for example a prepreg application. The B-stage resin can be subjected to final curing by heating again.

In addition, if necessary, within a range not impairing the objects of the present invention, the curable resin composition may contain various additives that conform to applications such as, for example, a plasticizer, a bulking agent, a filler and a strengthening agent (for example, glass fibers, asbestos fibers, boron fibers, carbon fibers, mineral silicates, mica, quartz powders, aluminum oxide hydrate, bentonite, wollastonite, kaolin, silica, Aerosil or metal powders), a pigment and a dye (for example, carbon black, oxide dyes and titanium dioxide), a flame retardant, a thixotropic agent, a flow controller, a mold releaser, an adhesion promoter, an antioxidant and a light stabilizer.

The curable resin composition of the present invention is useful as a matrix resin for a prepreg or a towpreg. A fiber for a prepreg or a towpreg may be selected from carbon, glass, aramid, boron, polyalkylene, quartz, polybenzimidazole, polyether ether ketone, polyphenylene sulfide, poly p-phenylene benzobisoxazole, silicon carbide, phenol formaldehyde, phthalate and naphthenate. These fibers may be a unidirectional fiber, a woven fiber, a short fiber, a non-woven textile fabric fiber, a long discontinuous fiber or the like.

The composition of the present invention (and the prepreg or the towpreg produced therefrom) are useful, in particular, for manufacturing and assembling of composite parts for aerospace industries and industry end applications, for binding of composite product parts with metal parts, for cores and core fillers for a sandwich structure, and surface finishing of composite products.

The composition of the present invention may be in a form of adhesive and in this case, the composition may comprise one or more adhesion promoters, flame retardants, fillers (for example, the inorganic fillers described above or different fillers), thermoplastic additives, reactive or non-reactive diluents, and thixotropic agents. In addition, the composition of the present invention in a form of adhesive may be shaped in a form of film and in this case, a supporting substrate includes those constituted from nylon, glass, carbon, polyester, polyalkylene, quartz, polybenzimidazole, polyether ether ketone, polyphenylene sulfide, poly p-phenylene benzobisoxazole, silicon carbide, phenol formaldehyde, phthalate and naphthenate.

The composition of the present invention may be applied by any technology known in the art, for example by using a mechanical method of application, for example applying in a form of bead on a substrate from a robot by using a caulking gun, or a swirl-shape application technology using a pump, a control system, an injection gun assembly, a remote injection device or application gun, or by any other manual application means using a fluid method and in this case, beads are sprayed at a distance from about 3 to about 10 mm of a substrate from a nozzle, and a pressure is from about 50 to about 300 bar, a speed is from about 200 to about 500 mm/s, an application temperature is from about 20° C. to about 65° C., and a diameter of nozzle is from about 0.5 to about 1.5 mm.

### EXAMPLES

Hereafter the present invention will be explained by the examples, the present invention is by no means limited to these examples.

Evaluation Method of Cured Products

Flexural strength and flexural modulus

A three-point bending test was carried out for a sample with 2 mm×10 mm×41.5 mm by using Autograph AGS-500B made by Shimadzu Co. under a condition with a supporting point distances of 20 mm and a bending rate of 2 mm/minute.

Fracture toughness value (K_{1c})

A measurement was carried out for a sample with a width of 4 mm×a thickness of 10 mm×a length of 82 mm by using Autograph AGS-500B made by Shimadzu Co. in conformity with ASTM E399.

Tg

A measurement was carried out by using Dynamic Viscosity Analyzer (DVA) DMS-6100 made by 811 NanoTechnology Inc. in air under a condition with a temperature rising rate of 5° C./minute and a frequency of 1 Hz.

SP Values of the Materials Used

Benzoxazine compound (the compound of the formula XV: 3,3′-(methylene di-4,1-phenylene)bis(3,4-dihydro-2H-1,3-benzoxazine)): SP value 11.1

Bisphenol A diglycidyl ether (DGEBA): SP value 9.4

n-Butyl methacrylate: SP value 8.5

Styrene: SP value 8.9

Glycidyl methacrylate: SP value 10.04

Benzyl methacrylate: SP value 9.8

n-Dodecyl methacrylate: SP value 8.3

### Example 1

As a matrix resin component ((a1) and (a2)), 100 parts by weight of a benzoxazine compound (the compound of the formula XV: 3,3′-(methylene di-4,1-phenylene)bis(3,4-dihydro-2H-1,3-benzoxazine)) and 30 parts by weight of a bisphenol A-type epoxy resin (DGEBA: bisphenol A diglycidyl ether) were mixed. The average SP value of this matrix resin component is 10.71. As the radically polymerizable component (b), n-butyl methacrylate and styrene were mixed in a molar ratio of 1:1. The weight average SP value of this radically polymerizable component is 8.7.

The matrix resin component and the radically polymerizable component were measured out 90% by weight and 10% by weight, respectively, which were sufficiently mixed together with further dicumyl peroxide (in amount of 1% by mole relative to the radically polymerizable component) at 50 to 80° C. to obtain a curable resin composition.

After stirring the mixture thoroughly, it was degassed and injected into a mold with 8 mm×15 mm×84 mm. The mold filled with the resin was heated in a stepwise manner for 1 hour at 120° C., 10 hours at 150° C., 1 hour at 180° C. and finally 3 hours at 200° C. to cure the resin and to obtain a cured product sample. Table 1 shows the composition and the evaluation results of physical properties.

### Examples 2 to 4

Cured product samples were obtained in a similar manner to Example 1 except that the proportions of the matrix resin component and the radically polymerizable component were altered as shown in Table 1. Table 1 shows the composition and the evaluation results of physical properties.

### Comparative Example 1

A cured product sample was obtained in a similar manner to Example 1 except that neither the radically polymerizable component nor dicumyl peroxide was used. Table 1 shows the composition and the evaluation results of physical properties.

TABLE 1

| | | | | |
|---|---|---|---|---|
| | | | | Comparative |
| Example 1 | Example 2 | Example 3 | Example 4 | Example 1 |

Composition (wt %)

| | | | | | |
|---|---|---|---|---|---|
| Box-1 (100 wt part) + | 90 | 86 | 82 | 78 | 100 |
| DGEBA (30 wt part) | | | | | |
| BuMA + St | 10 | 14 | 18 | 22 | — |
| (1:1 mol. ratio) | | | | | |
| DCP | 1 *¹⁾ | 1 *¹⁾ | 1 *¹⁾ | *¹⁾ | — |

Physical Properties of Cured Products

| | | | | | |
|---|---|---|---|---|---|
| K_{1c} (MN/m^{3/2}) | 0.75 | 0.81 | 0.85 | 0.86 | 0.71 |
| Flexural Strength | 222 | 208 | 202 | 196 | 228 |
| (MPa) | | | | | |
| Flexural Modulus | 4.89 | 4.82 | 4.58 | 4.33 | 4.48 |
| (GPa) | | | | | |
| Facture Elongation | 8.5 | 8.0 | 8.0 | 8.6 | 8.3 |
| (%) | | | | | |
| Tg (° C.) | 195 | 191 | 192 | 190 | 200 |

*¹⁾ The amount of DCP is a value of % by mole relative to BuMA + St.
Box-1: 3,3′-(methylene di-4,1-phenylene)bis(3,4-dihydro-2H-1,3-benzoxazine)
DGEBA: Bisphenol A diglycidyl ether
BuMA: n-Butyl methacrylate
St: Styrene
DCP: Dicumyl peroxide

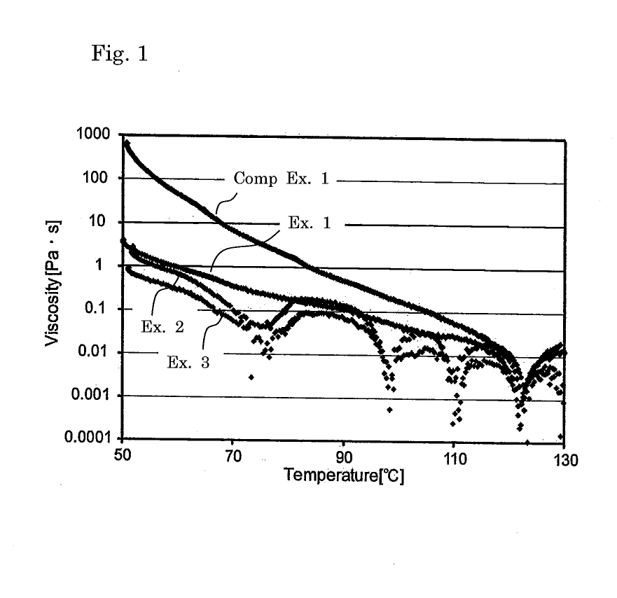

It is evident from the table that the vales of K_{1c} are improved and the toughness is improved for the cured products of the compositions according to the present invention. FIG. 1 also shows relationships between the viscosities of the compositions of Examples 1 to 3 and Comparative Example 1 vs. the temperature. The viscosities are improved significantly by addition of the radically polymerizable component.

### Example 5

As a matrix resin component (a), a benzoxazine compound (the compound of the formula XV: 3,3′-(methylene di-4,1-phenylene)bis(3,4-dihydro-2H-1,3-benzoxazine)) was solely used, whereas as the radically polymerizable component (b), the mixture of n-butyl methacrylate and styrene in a molar ratio of 1:1 was used in a similar manner to Example 1.

The matrix resin component and the radically polymerizable component were measured out 90% by weight and 10% by weight, respectively, which were sufficiently mixed together with further dicumyl peroxide (in amount of 1% by mole relative to the radically polymerizable component) at 50 to 80° C. to obtain a curable resin composition.

After stirring the mixture thoroughly, it was degassed and injected into a mold with 8 mm×15 mm×84 mm. The mold filled with the resin was heated in a stepwise manner for 1 hour at 120° C., 10 hours at 150° C. and 4 hours at 180° C. to obtain a cured product sample. Table 2 shows the composition and the evaluation results of physical properties.

### Examples 6 to 8

Cured product samples were obtained in a similar manner to Example 5 except that the proportions of the matrix resin component and the radically polymerizable component were altered as shown in Table 2. Table 2 shows the composition and the evaluation results of physical properties.

### Comparative Example 2

A cured product sample was obtained in a similar manner to Example 5 except that neither the radically polymerizable component nor dicumyl peroxide was used. Table 2 shows the composition and the evaluation results of physical properties.

TABLE 2

| | | | | |
|---|---|---|---|---|
| | | | | Comparative |
| Example 5 | Example 6 | Example 7 | Example 8 | Example 2 |

Composition (wt %)

| | | | | | |
|---|---|---|---|---|---|
| Box-1 | 90 | 86 | 82 | 78 | 100 |
| BuMA + St | 10 | 14 | 18 | 22 | — |
| (1:1 mol. ratio) | | | | | |
| DCP | 1 *¹⁾ | 1 *¹⁾ | 1 *¹⁾ | 1 *¹⁾ | — |

Physical Properties of Cured Products

| | | | | | |
|---|---|---|---|---|---|
| K_{1c} (MN/m^{3/2}) | 0.94 | 1.06 | 1.08 | 1.09 | 0.77 |
| Flexural Strength (MPa) | 216 | 233 | 203 | 194 | 230 |
| Flexural Modulus (GPa) | 4.70 | 4.71 | 4.44 | 4.15 | 4.92 |
| Facture Elongation (%) | 7.0 | 7.7 | 6.9 | 7.0 | 7.3 |
| Tg (° C.) | 197 | 193 | 192 | 191 | 207 |

*¹⁾ See table 1.
See Table 1 for abbreviations.

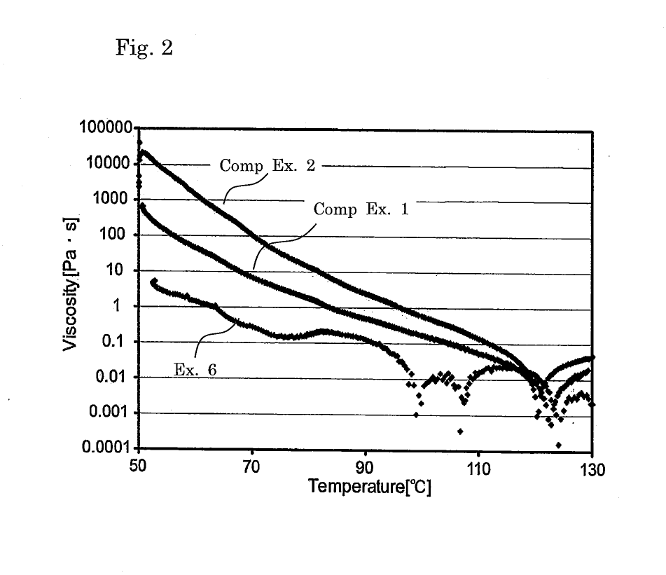

It is evident from the table that the vales of K_{1c} are improved and the toughness is improved for the cured products of the compositions according to the present invention. FIG. 2 also shows relationships between the viscosities of the compositions of Example 6, Comparative Example 1 and Comparative Example 2 vs. the temperature. The viscosities are improved significantly by addition of the radically polymerizable component.

### Example 9

As a matrix resin component (the component (a1) and the component (a2)), the mixture of 100 parts by weight of a benzoxazine compound (the compound of the formula XV: 3,3′-(methylene di-4,1-phenylene)bis(3,4-dihydro-2H-1,3-benzoxazine)) and 30 parts by weight of a bisphenol A-type epoxy resin (DGEBA: bisphenol A diglycidyl ether) was used, as same as Example 1. As the radically polymerizable component (b), glycidyl methacrylate was further added to the mixture of n-butyl methacrylate and styrene in a molar ratio of 1:1 so that the concentration of glycidyl methacrylate became 3% by mole. That is to say, the molar ratio of n-butyl methacrylate, styrene and glycidyl methacrylate is 48.5:48.5:3. The weight average SP value of this radically polymerizable component is 8.75.

The matrix resin component and the radically polymerizable component were measured out 82% by weight and 18% by weight, respectively, which were sufficiently mixed together with further dicumyl peroxide (in amount of 1% by mole relative to the radically polymerizable component) at 50 to 80° C. to obtain a curable resin composition.

After stirring the mixture thoroughly, it was degassed and injected into a mold with 8 mm×15 mm×84 mm. In a similar manner to Example 1, the mold filled with the resin was heated in a stepwise manner for 1 hour at 120° C., 10 hours at 150° C., 1 hour at 180° C. and finally 3 hours at 200° C. to cure the resin and to obtain a cured product sample. Table 3 shows the composition and the evaluation results of physical properties.

### Examples 10 and 11

While keeping at 1:1 the molar ratio of n-butyl methacrylate and styrene, the proportion of glycidyl methacrylate in the radically polymerizable component (b) was set at 5% by mole (Example 10) or 10% by mole (Example 11). Except this, cured product samples were obtained in a similar manner to Example 9. Table 3 shows the composition and the evaluation results of physical properties. By comparison, Table 3 also shows data of Example 3 and Comparative Example 1. The weight average SP value of the radically polymerizable component is 8.78 and 8.86, for Example 10 and Example 11, respectively.

TABLE 3

| | Example | Example | | Comparative |
|---|---|---|---|---|
| Example 9 | 10 | 11 | Example 3 | Example 1 |

Composition (wt %)

| | | | | | |
|---|---|---|---|---|---|
| Box-1 (100 wt part) + | 82 | 82 | 82 | 82 | 100 |
| DGEBA (30 wt part) | | | | | |
| BuMA + St + GMA | 18 | 18 | 18 | 18 | — |
| % by mole of GMA | 3 | 5 | 10 | 0 | |
| DCP | 1 *¹⁾ | 1 *¹⁾ | 1 *¹⁾ | 1 *¹⁾ | — |

Physical Properties of Cured Products

| | | | | | |
|---|---|---|---|---|---|
| K_{1c} (MN/m^{3/2}) | 0.89 | 0.95 | 0.81 | 0.85 | 0.71 |
| Flexural Strength (MPa) | 204 | 212 | 219 | 202 | 228 |
| Flexural Modulus (GPa) | 5.02 | 5.07 | 5.12 | 4.58 | 4.48 |
| Facture Elongation (%) | 7.6 | 7.9 | 7.9 | 8.0 | 8.3 |
| Tg (° C.) | 195 | 195 | 196 | 192 | 200 |

*¹⁾ See table 1.
GMA: Glycidyl methacrylate
See Table 1 for other abbreviations.

### Example 12

As a matrix resin component (the component (a)), a benzoxazine compound (the compound of the formula XV: 3,3′-(methylene di-4,1-phenylene)bis(3,4-dihydro-2H-1,3-benzoxazine)) was solely used, whereas glycidyl methacrylate was further added to the mixture of n-butyl methacrylate and styrene in a molar ratio of 1:1 so that the concentration of glycidyl methacrylate became 3% by mole as the radically polymerizable component (b).

The matrix resin component and the radically polymerizable component were measured out 82% by weight and 18% by weight, respectively, which were sufficiently mixed together with further dicumyl peroxide (in amount of 1% by mole relative to the radically polymerizable component) at 50 to 80° C. to obtain a curable resin composition.

After stirring the mixture thoroughly, it was degassed and injected into a mold with 8 mm×15 mm×84 mm. In a similar manner to Example 5, the mold filled with the resin was heated in a stepwise manner for 1 hour at 120° C., 10 hours at 150° C. and 4 hours at 180° C. to obtain a cured product sample. Table 4 shows the composition and the evaluation results of physical properties.

### Examples 13 and 14

While keeping at 1:1 the molar ratio of n-butyl methacrylate and styrene, the proportion of glycidyl methacrylate in the radically polymerizable component (b) was set at 5% by mole (Example 13) or 10% by mole (Example 14). Otherwise, cured product samples were obtained in a similar manner to Example 12. Table 4 shows the composition and the evaluation results of physical properties. By comparison, Table 4 also shows data of Example 7 and Comparative Example 2.

TABLE 4

| Example | Example | Example | | Comparative |
|---|---|---|---|---|
| 12 | 13 | 14 | Example 7 | Example 2 |

Composition (wt %)

| | | | | | |
|---|---|---|---|---|---|
| Box-1 | 82 | 82 | 82 | 82 | 100 |
| BuMA + St + GMA | 18 | 18 | 18 | 18 | — |
| % by mole of GMA | 3 | 5 | 10 | 0 | |
| DCP | 1 *¹⁾ | 1 *¹⁾ | 1 *¹⁾ | 1 *¹⁾ | — |

Physical Properties of Cured Products

| | | | | | |
|---|---|---|---|---|---|
| K_{1c} (MN/m^{3/2}) | 1.10 | 0.90 | 0.76 | 1.08 | 0.77 |
| Flexural Strength (MPa) | 224 | 209 | 205 | 203 | 230 |
| Flexural Modulus (GPa) | 4.86 | 4.80 | 4.89 | 4.44 | 4.92 |
| Facture Elongation (%) | 7.3 | 6.7 | 6.4 | 6.9 | 7.3 |
| Tg (° C.) | 198 | 195 | 194 | 192 | 207 |

*¹⁾ See Table 1.
See Tables 1 and 3 for other abbreviations.

### Comparative Example 3

As a matrix resin component ((a1) and (a2)), the mixture of 100 parts by weight of a benzoxazine compound (the compound of the formula XV: 3,3′-(methylene di-4,1-phenylene)bis(3,4-dihydro-2H-1,3-benzoxazine)) and 30 parts by weight of a bisphenol A-type epoxy resin (DGEBA: bisphenol A diglycidyl ether) was used. As the radically polymerizable component (b), benzyl methacrylate (SP value: 9.8) is used. The matrix resin component and the radically polymerizable component were measured out 90% by weight and 10% by weight, respectively, which were sufficiently mixed together with further dicumyl peroxide (in amount of 1% by mole relative to the radically polymerizable component) at 50 to 80° C. to obtain a curable resin composition.

A sample of the cured product was obtained and the properties thereof was evaluated by repeating the operation as described in Example 1. However, K_{1c} of the cured product was 0.70, showing it was not toughened.

### Examples 15 to 19

The compositions of Examples 15 to 17 were prepared by using the same matrix resin component as that used in Example 1, and using respective single monomers as shown in Table 5 as the radically polymerizable component. Cured product samples were obtained in a similar manner to Example 1. The compositions of Examples 18 to 19 were prepared by using the same matrix resin component as that used in Example 5, and using respective single monomers as shown in Table 6 as the radically polymerizable component. Cured product samples were obtained in a similar manner to Example 5. Tables 5 and 6 show the compositions and the evaluation results of physical properties.

TABLE 5

| Example | Example | Example |
|---|---|---|
| 15 | 16 | 17 |

Composition (wt %)

| | | | |
|---|---|---|---|
| Box-1 (100 wt part) + | 86 | 86 | 86 |
| DGEBA (30 wt part) | | | |
| BuMA | 14 | | |
| DMA | | 14 | |
| St | | | 14 |
| DCP | 1 *¹⁾ | 1 *¹⁾ | 1 *¹⁾ |

Physical Properties of Cured Products

| | | | |
|---|---|---|---|
| K_{1c} (MN/m^{3/2}) | 1.02 | 0.91 | 0.95 |
| Flexural Strength (MPa) | 220 | 179 | 223 |
| Flexural Modulus (GPa) | 4.67 | 4.37 | 4.93 |
| Facture Elongation (%) | 8.3 | 7.3 | 8.1 |
| Tg (° C.) | 189 | 193 | 192 |

*¹⁾ See table 1.
DMA: n-dodecyl methacrylate
See Table 1 for other abbreviations.

TABLE 6

| Example | Example |
|---|---|
| 18 | 19 |

Composition (wt %)

| | | |
|---|---|---|
| Box-1 | 86 | 86 |
| BuMA | 14 | |
| St | | 14 |
| DCP | 1 *¹⁾ | 1 *¹⁾ |

Physical Properties of Cured Products

| | | |
|---|---|---|
| K_{1c} (MN/m^{3/2}) | 0.96 | 0.92 |
| Flexural Strength (MPa) | 222 | 215 |
| Flexural Modulus (GPa) | 4.49 | 4.75 |
| Facture Elongation (%) | 7.9 | 6.8 |
| Tg (° C.) | 191 | 197 |

*¹⁾ See table 1.
See Table 1 for abbreviations.

### Example 20

In this example, a polyeter compound prepared in the following manner is used as a toughener component (d).

4 moles of bisphenol A, 3.58 moles of polypropylene glycol diglycidyl ether (DER 732 available from Dow Chemical Company) and 1.96 moles of bisphenol A epoxy resin (DER331 available from Dow Chemical Company) were reacted in the presence of 0.3% by weight of tetrabutyl ammonium bromide as a catalyst at about 150° C. for several hours to obtain a polyeter compound (may be referred to as TEPO). The obtained polyeter compound has an epoxy equivalent of 1300-1500 (g/eq) and a molecular weight (Mw, by GPC) of 7500-9000.

As a matrix resin component (a), a benzoxazine compound (the compound of the formula XV: 3,3′-(methylene di-4,1-phenylene)bis(3,4-dihydro-2H-1,3-benzoxazine)) was solely used. As the radically polymerizable component (b), the mixture of n-butyl methacrylate and styrene in a molar ratio of 1:1 was used in a similar manner to Example 1.

80 parts by weight of the matrix resin component (a) and 20 parts by weight of the toughener component (d) were mixed. This mixture and the radically polymerizable component were measured out 82% by weight and 18% by weight, respectively, which were sufficiently mixed together with further dicumyl peroxide (in amount of 1% by mole relative to the radically polymerizable component) at 50 to 80° C. to obtain a curable resin composition.

Cured product samples were obtained in a similar manner to Example 5. Table 7 shows the composition and the evaluation results of physical properties.

### Comparative Example 4

A cured product sample was obtained in a similar manner to Example 20 except that neither the radically polymerizable component nor dicumyl peroxide was used. Table 7 shows the composition and the evaluation results of physical properties. The result of Comparative example 2 is again shown in Table 7.

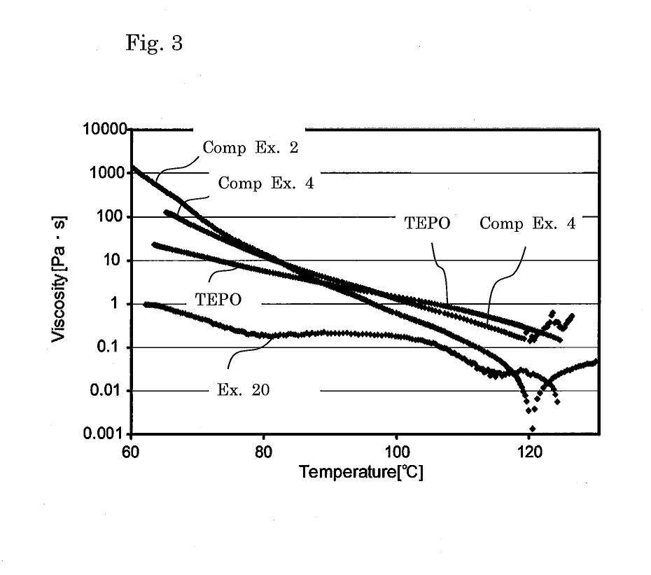

FIG. 3 shows relationships between the viscosities of the compositions of Example 20 and Comparative Examples 4 and 2 vs. the temperature, together with the result of TEPO. Table 7 shows the viscosity at 70° C. and 100° C.

TABLE 7

| Example | Comparative | Comparative |
|---|---|---|
| 20 | Example 4 | Example 2 |

Composition (wt %)

| | | | |
|---|---|---|---|
| Box-1 (80 wt part) + | 82 | 100 | |
| TEPO (20 wt part) | | | |
| Box-1 | | | 100 |
| BuMA + St (1:1 mol. ratio) | 18 | — | — |
| DCP | 1 *¹⁾ | — | — |

Viscosity (Pa · s)

| | | | |
|---|---|---|---|
| 70° C. | 0.48 | 58.2 | 105.1 |
| 100° C. | 0.18 | 1.30 | 0.62 |

Physical Properties of Cured Products

| | | | |
|---|---|---|---|
| K_{1c} (MN/m^{3/2}) | 1.29 | 1.30 | 0.77 |
| Flexural Strength (MPa) | 181 | 215 | 230 |
| Flexural Modulus (GPa) | 3.73 | 4.54 | 4.92 |
| Facture Elongation (%) | 9.7 | 8.0 | 7.3 |
| Tg (° C.) | 207 | 202 | 207 |

*¹⁾ See table 1.
See Table 1 for abbreviations.

It is evident from the table that the vales of K_{1c} are improved and the toughness is improved by the addition of TEPO. In addition, the viscosities are improved significantly by addition of the radically polymerizable component.

### Examples 21 to 23

Using the same materials as used in Example 20, 90 parts by weight of the matrix resin component (a) and 10 parts by weight of the toughener component (d) were mixed. The proportions of the radically polymerizable component were altered as shown in Table 8 and cured product samples were obtained in a similar manner to Example 20. Table 8 shows the composition and the evaluation results of physical properties.

### Comparative Example 5

A cured product sample was obtained in a similar manner to Example 21 except that neither the radically polymerizable component nor dicumyl peroxide was used. Table 8 shows the composition and the evaluation results of physical properties.

TABLE 8

| Example | Example | Example | Comparative |
|---|---|---|---|
| 21 | 22 | 23 | Example 5 |

Composition (wt %)

| | | | | |
|---|---|---|---|---|
| Box-1 (90 wt part) + | 90 | 86 | 82 | 100 |
| TEPO (10 wt part) | | | | |
| BuMA + St (1:1 mol. | 10 | 14 | 18 | — |
| ratio) | | | | |
| DCP | 1 *¹⁾ | 1 *¹⁾ | 1 *¹⁾ | — |

Physical Properties of Cured Products

| | | | | |
|---|---|---|---|---|
| K_{1c} (MN/m^{3/2}) | 1.18 | 1.20 | 1.25 | 1.11 |
| Flexural Strength | 236 | 221 | 203 | 236 |
| (MPa) | | | | |
| Flexural Modulus | 4.65 | 4.43 | 4.28 | 4.84 |
| (GPa) | | | | |
| Facture Elongation | 8.9 | 8.9 | 8.2 | 7.9 |
| (%) | | | | |
| Tg (° C.) | 189 | 190 | 187 | 191 |

*¹⁾ See table 1.
See Table 1 for other abbreviations.

### INDUSTRIAL APPLICABILITY

Since the benzoxazine compound-based thermally curable resin composition of the present invention has excellent mechanical properties and a low viscosity, the composition is useful as a structural material of airplanes and automobiles, and a sealant for electronic components.

What is claimed is:

1. A curable resin composition comprising:
(a) a matrix resin component containing a benzoxazine compound (a1),
(b) a radically polymerizable component containing a radically polymerizable monomer having solubility parameter (SP) value that is different by 1.0 to 4.1 from the SP value of the matrix resin component, and
(c) a radical polymerization initiator.

2. A curable compositions comprising:
(a) a matrix resin component containing a benzoxazine compound (a1),
(b) a radically polymerizable component containing a radically polymerizable monomer that is polymerizable in the presence of the matrix resin component (a), and
(c) a radical polymerization initiator.

3. The curable composition according to claim 2, wherein the polymerizable monomer has a solubility parameter (SP) value that is different by 1.0 to 4.1 from the SP value of the matrix resin component.

4. The composition according to claim 1, wherein the SP value of the radically polymerizable component (b) is from 7 to 10.5.

5. The composition according to claim 1, the matrix resin component (a) further comprising a co-curable resin component (a2) that is curable with or in the presence of the benzoxazine compound (a1).

6. The composition according to claim 4, wherein the co-curable resin component (a2) comprises a resin selected from the group consisting of epoxy resins, cyanate resins, phenol resins, melamine resins, urea resins and a mixture of at least two of these resins.

7. The composition according to claim 1, wherein the radically polymerizable component (b) comprises monomer(s) selected from the group consisting of styrene-based monomers, (meth)acrylates, and a mixture of at least two of these monomers.

8. The composition according to claim 1, wherein the radically polymerizable component (b) further comprises a monomer containing, in addition to a radically polymerisable functional group, a second functional group co-curable with the benzoxazine component (a) or curable in the presence of the benzoxazine component (a).

9. The composition according to claim 8, wherein the second functional group is selected from the group consisting to epoxy group and cyanate group.

10. The composition according to claim 1, wherein the radical polymerization initiator (c) comprises a compound that produces one or more radicals when heated (thermal radical initiator).

11. The composition according to claim 1, wherein the benzoxazine compound comprises one or more of compound selected from 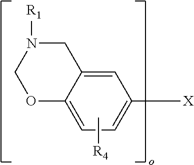
wherein o is 1-4, X is selected from the group consisting of a direct bond (when o is 2), alkyl (when o is 1), alkylene (when o is 2-4), carbonyl (when o is 2), thiol (when o is 1), thioether (when o is 2), sulfoxide (when o is 2), and sulfone (when o is 2), R₁ is selected from the group consisting of hydrogen, alkyl, and aryl, and R₄ is selected from hydrogen, halogen, alkyl, and alkenyl; and 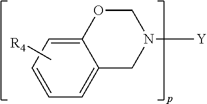
wherein p is 2, Y is selected from the group consisting of biphenyl (when p is 2), diphenyl methane (when p is 2), diphenyl isopropane (when p is 2), diphenyl sulfide (when p is 2), diphenyl sulfoxide(when p is 2), diphenyl sulfone (when p is 2), and diphenyl ketone (when p is 2), and R₄ is selected from the group consisting of hydrogen, halogen, alkyl and alkenyl.

12. The composition according to claim 1, further comprising an additional toughener component (d).

13. The composition according to claim 1, wherein said composition comprises:
from 10% to 99.7% by weight of the matrix resin component, based on the total amount of the composition,
from 0.3 to 35% by weight of the radically polymerizable component, based on the total amount of the composition, and
the radical polymerization initiator in an amount of 0.01 to 10 parts by weight relative to 100 parts by weight of the radically polymerizable component.

14. A method of producing a cured product comprising heating the composition according to claim 1.

15. The method according to claim 14 wherein the method comprising the steps of:
exposing the composition to a first condition where the polymerization of the radically polymerizable component (b) takes place predominantly, and
exposing the composition to a second condition where the curing of the matrix resin component (a) takes place faster than under the first condition.

16. The method of claim 14, wherein the method comprising the steps of:
exposing the composition for about 10 minutes to about 5 hours to a first temperature of about 100° C. to about 140° C.;
exposing the composition for about 1 hour to about 24 hours to a second temperature, which is higher than the first temperature; and
optionally exposing the composition for about 30 minutes to about 15 hours to a temperature, which is higher than the second temperature.

17. A cured product which is obtained by curing the composition of claim 1.

18. An article comprising the cured product of claim 17.
